(19) United States
(12) Patent Application Publication
(10) Pub. No.: US 2004/0217683 A1
(43) Pub. Date: Nov. 4, 2004

(54) COLOR CATHODE RAY TUBE AND MASK ASSEMBLY FOR SAME

(76) Inventors: Hirohisa Nishino, Tokyo (JP); Haruo Watanuki, Tokyo (JP)

Correspondence Address: BIRCH STEWART KOLASCH & BIRCH, PO BOX 747, FALLS CHURCH, VA, 22040-0747, US

(21) Appl. No.: 10/718,808

(22) Filed: Nov. 24, 2003

(30) Foreign Application Priority Data
Apr. 30, 2003 (JP) 2003-124813

(51) Int. Cl. H01J 29/07

(52) U.S. Cl. 313/402; 313/403; 313/407

(57) ABSTRACT

In a mask assembly for a color cathode ray tube, the color selection mask has the form of a thin metal plate with relatively long vertical slits alternating with vertical columns of relatively short slots, at least in the central screen area. The metal strips bounding a column of slots are joined by real bridges, which define the slots. Dummy bridges project from the metal strips into the slits, to reduce the electron beam flux transmitted through the slits to approximately the same level as the electron beam flux transmitted through the columns of slots, thereby preventing brightness irregularities on the screen. The alternate arrangement of slits and columns of slots also reduces vibration and prevents doming.

### BACKGROUND OF THE INVENTION

1. Field of the Invention

The present invention relates to a color cathode ray tube and its color selection mask assembly, more particularly to a mask assembly of the tension type in which the color selection mask is suspended under constant tension in a mask frame.

2. Description of the Related Art

The color cathode ray tubes used in television sets, computer monitors, and the like have a color selection electrode, referred to herein as a color selection mask, formed by selectively etching a thin metal plate to form a large number of openings for the passage of electron beams.

One representative type of color selection mask is an aperture grille in which the openings take the form of slits between a large number of parallel metal strips (grid elements). The aperture grille is supported by a mask frame that applies tension in the longitudinal direction of the metal strips. Vibration is damped by friction between the metal strips and a damper wire, which is a metal wire suspended in a direction substantially perpendicular to the longitudinal direction of the grid elements.

In another representative type of color selection mask, a large number of substantially rectangular openings, referred to herein as slots, are formed in the thin metal plate for the passage of electron beams, the slots being elongated in the vertical screen direction. A color selection mask having this construction is referred to as a real bridge mask because it has metal bridges joining adjacent metal strips in the horizontal screen direction.

A recent trend is for color cathode ray tubes to have flatter faceplates, thus requiring flatter color selection masks. Since it is difficult to maintain flatness simply by securing a color selection mask to a mask frame, the above-mentioned real bridge mask, like the aperture grille, is suspended under constant tension in the mask frame. A color selection mask having this structure is referred to as a real bridge tension mask.

In a color selection mask, if the metal strips vibrate due to external impact, vibration propagation from speakers, or the like, the vibration may become conspicuously evident as a vibration of the image on the screen; the vibration must therefore be damped. Since the above-mentioned real bridge tension mask has a structure in which the metal strips are mutually interconnected by the real bridges, vibration propagates more readily-than in an aperture grille, and even a local impact can easily cause the color selection mask to vibrate throughout its entire area. This vibration cannot be adequately damped just by the application of tension from the mask frame, or by the damper wires used in an aperture grille.

To solve this vibration problem, a structure has been proposed in which a vibration damper is placed in contact with the peripheral edges of the color selection mask so as to damp vibration by contact friction (see, for example, reference 1 in the patent references listed below). In another proposed structure for suppressing propagation of vibration, the number of real bridges gradually decreases from the central portion of the color selection mask to the peripheral portion; this structure may also be combined with damper wires (see, for example, references 2 and 3).

Since the above-mentioned real bridge mask has metal strips mutually interconnected by real bridges in the horizontal screen direction, it is susceptible to thermal expansion in the horizontal screen direction, resulting in a problem of doming. Doming, which occurs when an image is displayed for an extended time, for example, is a so-called color shift distortion caused by thermal expansion in the entire plane area of the color selection mask due to increasing temperature, and the resulting change in position of the openings for the passage of electron beams in the color selection mask relative to the phosphor screen. One way to prevent doming is to suspend the color selection mask under strong tension in the mask frame, but this requires an increase in the rigidity of the mask frame, leading to increased weight and higher cost. Therefore, a type of color selection mask has been proposed in which slit-shaped openings (referred to herein as slits) are formed as in an aperture grille, and columns of rectangular openings (referred to herein as slots) are formed in each metal strip, both types of the openings allowing the passage of electron beams (see, for example, reference 4).

### Patent References

1. Japanese Patent No. 3300669 (p. 7, FIG. 9)

2. Japanese Unexamined Patent Application Publication No. 2002-42670 (pp. 4-5, FIG. 2)

3. Japanese Unexamined Patent Application Publication No. 2002-42675 (p. 5, FIG. 2)

4. Japanese Unexamined Patent Application Publication No. 2003-7222 (p. 3, FIG. 1)

The structure having a vibration damper at the peripheral edges of the color selection mask as described in reference 1 can damp vibration in the vicinity of the damper, but cannot suppress propagation of vibration. Therefore, if vibration occurs near the center of the screen, for example, an adequate vibration damping effect cannot be obtained: the vibration propagates over the entire plane area of the color selection mask except in the vicinity of the vibration damper.

The structure in which the number of real bridges gradually decreases from the central portion of the color selection mask to the peripheral portions, as described in references 2 and 3, leaves real bridges present over nearly the entire area of the color selection mask, so it does not differ greatly from the general real bridge tension mask structure; accordingly, an adequate vibration damping effect is not obtained.

In the aperture grille described at the beginning of the preceding discussion, the duration of vibration can be reduced by installing damper wires, but the initial vibration amplitude, occurring immediately after the vibration starts, is large because there are a large number of mutually independent metal strips (not interconnected by real bridges).

Doming is mitigated by supplementing the slits with columns comprising a large number of slots, referred to herein as slot columns, formed in the metal strips as described in reference 4, so that the mask has both slits and slot columns, but more total electron beam flux passes through the slits than through the slot columns, so the resulting presence of high and low luminance columns on the screen creates brightness irregularities that degrade picture quality.

An object of the present invention is to provide a color cathode ray tube and mask assembly that can damp vibration, can prevent doming and brightness irregularities, and can improve picture quality.

### SUMMARY OF THE INVENTION

A mask assembly for a color cathode ray tube according to the present invention includes a color selection mask and a mask frame supporting the color selection mask, the color selection mask having the form of a thin metal plate with a plurality of openings for the passage of electron beams, the color selection mask having an effective screen area within which a horizontal screen direction and a vertical screen direction are defined. The openings in the effective screen area include slits and slot columns, both extending in the vertical screen direction, the slots extending for a shorter distance than the slits in the vertical screen direction, slits alternating with slot columns in the horizontal screen direction. The slot columns have a plurality of real bridges joining the pair of metal strips bounding each slot column so as to define boundaries between the slots in the column. A plurality of dummy bridges project from the metal strips into each of the slits without joining the metal strips.

### BRIEF DESCRIPTION OF THE DRAWINGS

In the attached drawings:

FIG. 1 is a side sectional drawing of a color cathode ray tube having a mask assembly according to a first embodiment of the invention;

FIG. 2A is a perspective view of the mask assembly according to the first embodiment of the invention;

FIG. 2B is an enlarged perspective view showing part of the color selection mask in the mask assembly in FIG. 2A;

FIG. 3A is a perspective view of a mask assembly according to a second embodiment of the invention;

FIG. 3B is an enlarged perspective view showing a central part of the color selection mask in the mask assembly in FIG. 3A;

FIG. 3C is an enlarged perspective view showing a peripheral part of the color selection mask in the mask assembly in FIG. 3A;

FIG. 4A is a plan view showing the effective screen area of the color selection mask in the mask assembly according to the second embodiment of the invention;

FIG. 4B is an enlarged plan view showing a central part of the effective screen area in FIG. 4A;

FIG. 4C is an enlarged plan view showing a peripheral part of the effective screen area in FIG. 4A;

FIG. 5A is a plan view showing the effective screen area of the color selection mask in a mask assembly according to a third embodiment of the invention;

FIG. 5B is an enlarged plan view showing part of the effective screen area in FIG. 5A;

FIG. 6A is a plan view showing the effective screen area of the color selection mask in a mask assembly according to a fourth embodiment of the invention;

FIG. 6B is an enlarged plan view showing part of the effective screen area in FIG. 6A;

FIG. 7A is an enlarged plan view of the dummy bridges in the first to fourth embodiments of the invention; and

FIGS. 7B and 7C are enlarged plan views showing modified examples of the dummy bridges in FIG. 7A.

### DETAILED DESCRIPTION OF THE INVENTION

The invention will now be described on the basis of the embodiments illustrated in the drawings.

### First Embodiment

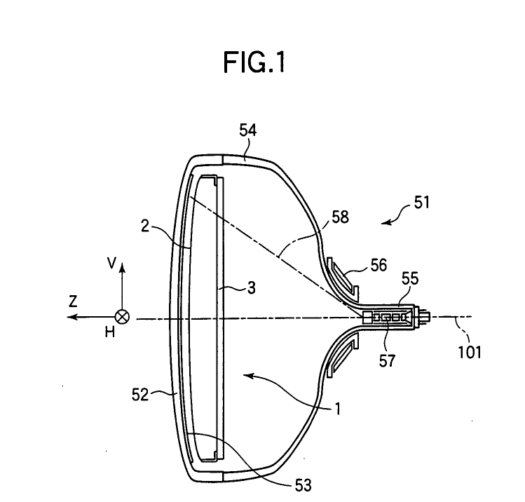

FIG. 1 is a side sectional drawing showing the basic structure of a color cathode ray tube having a mask assembly 1 according to a first embodiment of the invention. The glass bulb 51 that forms the vacuum enclosure of the color cathode ray tube in FIG. 1 comprises a faceplate 52 on the inner surface of which a phosphor screen 53 is formed, a funnel 54 joined to the rear side of the faceplate 52 and having an approximate funnel shape, and a neck 55 formed continuously with the funnel 54 at the narrow end thereof. The bulb axis 101 is the central axis of this glass bulb 51. Electron guns 57 are mounted in the neck 55 so as to be positioned on the bulb axis 101. A deflection yoke 56 is provided around the narrow end of the funnel 54 to deflect the three electron beams 58 emitted from the electron guns 57.

A color selection mask 2 is provided inside the faceplate 52, facing the phosphor screen 53. The color selection mask 2 is a so-called tension mask, which is formed by selectively etching a thin metal plate to create a large number of openings for the passage of electron beams and is suspended under constant tension in a mask frame 3. The color selection mask 2 and mask frame 3 together constitute a mask assembly 1. The color selection mask 2 has a color selection function that makes the three electron beams 58 emitted from the electron guns 57 incident on the red, green, and blue phosphors of the phosphor screen 53. The mask frame 3 is secured inside the faceplate 52 by metal fittings not shown in the drawing.

The phosphor screen 53 has an approximately rectangular shape, the direction parallel to the long sides thereof being defined as the horizontal screen direction or H-direction, the direction parallel to the short sides thereof being defined as the vertical screen direction or V-direction. The horizontal and vertical screen directions are orthogonal with respect to the bulb axis 101 (Z-axis) of the glass bulb 51.

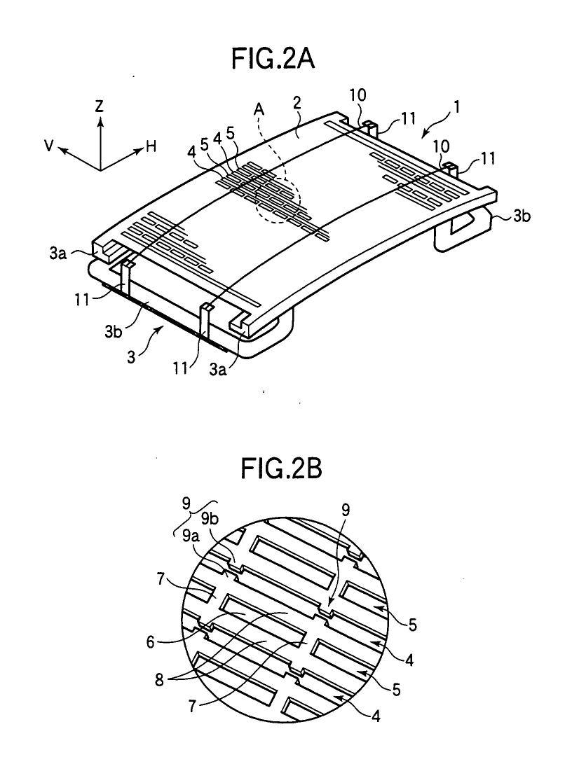

FIG. 2A is a perspective view of the mask assembly 1 according to the first embodiment. As described above and as shown in FIG. 2A, the mask assembly 1 has a mask frame 3, which is made from steel, and a color selection mask 2 comprising a thin metal plate in which openings for the passage of electron beams are formed. The color selection mask 2 has an approximately rectangular shape with long sides extending in the H-direction and short sides extending in the V-direction. The part of the color selection mask 2 excluding the horizontally and vertically peripheral parts is the effective screen area, corresponding to the phosphor screen 53. The mask frame 3 comprises a pair of horizontally elongate members 3a to which the two long sides of the color selection mask 2 are welded, and a pair of vertically elongate members 3b that join corresponding ends of the two horizontally elongate members 3a. The vertically elongate members 3b urge the pair of horizontally elongate members 3a apart so as to apply tension to the color selection mask 2 in the V-direction.

Two pairs of damper springs 11 are welded to the vertically elongate members 3b. The two damper springs 11 welded to one vertically elongate member 3b face the two damper springs 11 welded to the other vertically elongate member 3b. Damper wires 10 are suspended in the H-direction between the opposing damper springs 11. The damper wires 10 directly contact the surface of the color selection mask 2 to damp vibration. The damper springs 11 and damper wires 10 constitute a vibration damping mechanism by which vibration of the color selection mask 2 is promptly damped.

FIG. 2B is an enlarged perspective view showing the part of the color selection mask 2 enclosed by the dotted line in FIG. 2A. As shown in FIG. 2B, the openings in the effective screen area of the color selection mask 2 include slits 4, which are slit-shaped openings extending in the V-direction, and slot columns 5, which comprise rectangular openings aligned in the V-direction, the slits 4 alternating with the slot columns 5 in the H-direction. Each slot column 5 comprises a large number of rectangular openings 6, referred to herein as slots 6, formed at regular intervals in the V-direction. Each slot 6 extends for a shorter distance than the slits 4 in the V-direction. The color selection mask 2 has a large number of metal strips 8 extending in the V-direction and aligned parallel with one another in the H-direction; the slits 4 are formed between adjacent metal strips 8. The slots 6 are formed by a large number of real bridges 7, which join adjacent metal strips 8 and are spaced at regular intervals in the V-direction.

The slits 4 have multiple dummy bridges 9 disposed at regular intervals in the V-direction. Each of the dummy bridges 9 comprises a pair of projections 9a, 9b projecting toward each other from the metal strips 8 on both sides of a slit 4. The projections 9a, 9b do not contact each other; a gap is left between them. The dummy bridges 9 are disposed at the same intervals in the V-direction as the real bridges 7 of the slot columns 5. The dummy bridges 9 and real bridges 7 are aligned at the same positions in the V-direction.

Next, the effects of the mask assembly 1 according to the first embodiment will be described. According to the first embodiment, the color selection mask 2 of the mask assembly 1 has slits 4 and slot columns 5 formed between adjacent metal strips 8, the slot columns 5 having a large number of the real bridges 7, slits 4 alternating with slot columns 5 in the H-direction. In other words, a large number of pairs of metal strips 8 joined by real bridges 7 are disposed in parallel alignment with each other, with slits 4 in between. Since vibration propagation is interrupted by the slits 4, vibration propagation can be better suppressed than in a conventional real bridge tension mask in which all the metal strips are interconnected by real bridges. Further, since all the metal strips 8 of the color selection mask 2 are in contact with the damper wires 10, if vibration occurs in the metal strips 8, it can be promptly damped by contact friction.

As described above, since the color selection mask 2 has a construction comprising a large number of aligned pairs of metal strips 8 joined by real bridges 7, the metal strips have higher rigidity than in an aperture grille having a large number of mutually independent metal strips (not interconnected by real bridges); accordingly, for the same intensity of impact, the amplitude of vibration of the metal strips 8 will be smaller. Visible vibration of the image on the screen can thereby be reduced even when the color selection mask 2 is continuously stimulated by speakers or the like.

In a conventional real bridge tension mask, thermal expansion occurs throughout the color selection mask because all metal strips are mutually interconnected by real bridges in the H-direction. In contrast, as described above, the color selection mask 2 in the first embodiment has a structure in which slits 4 separate adjacent pairs of metal strips 8 joined by real bridges 7, so that while each pair of metal strips 8 expands thermally, thermal expansion of the color selection mask 2 as a whole becomes extremely small. Therefore, changes in the H-directional position relative to the phosphor screen 53 (FIG. 1) of the openings (slits 4 and slots 6) for the passage of the electron beams can be suppressed, and doming can be prevented.

Furthermore, since the color selection mask 2 in the first embodiment has a large number of dummy bridges 9 in the slits 4, the total electron beam flux passing through the slits 4 can be made to approach the total flux passing through the slot columns 5. As a result, brightness irregularities, in which high and low luminance columns occur alternately, can be suppressed, and picture quality can be improved.

As described above, according to the first embodiment, vibration propagation in the metal strips 8 in the color selection mask 2 can be suppressed and the amplitude of the vibration caused by impact can be reduced, so a better vibration damping effect can be obtained than in a conventional real bridge tension mask or an aperture grille. Since overall thermal expansion of the color selection mask can be suppressed, doming, which is observed in conventional real bridge tension masks, can also be prevented and picture quality can be improved. Further, it is not necessary to suspend the color selection mask under strong tension in the mask frame to mitigate doming, so a lightweight, low-cost mask assembly 1 can be used. Additionally, the provision of dummy bridges 9 in the slits 4 enables the total electron beam flux passing through the slits 4 to approach the total electron beam flux passing through the slot columns 5 so that brightness irregularities can be suppressed and picture quality can be improved.

### Second Embodiment

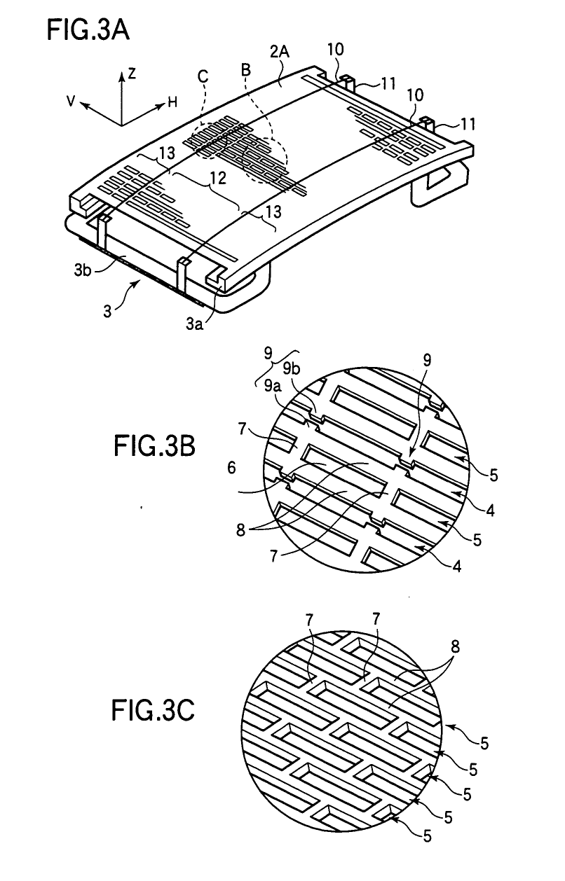

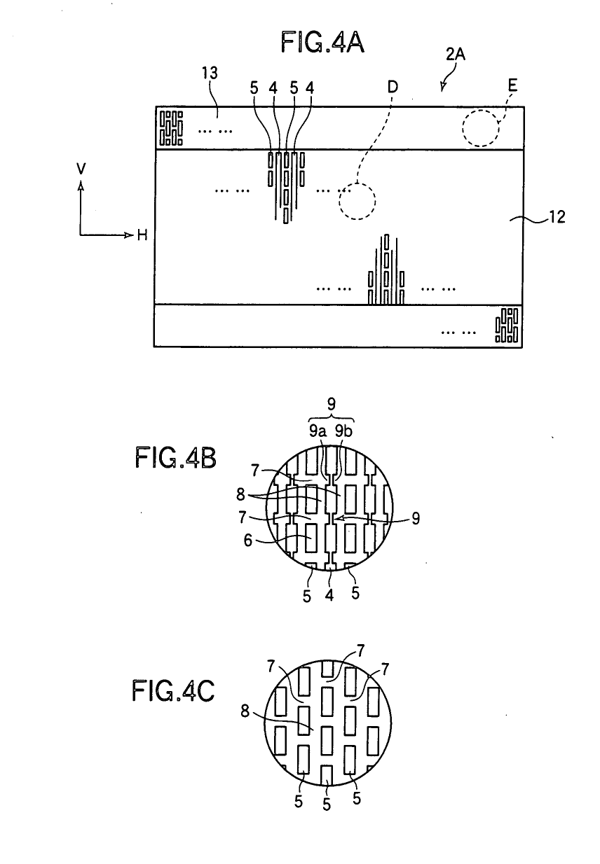

FIG. 3A is a perspective view of a mask assembly according to a second embodiment. FIG. 3B is an enlarged perspective view showing the vertically central part of the color selection mask enclosed by the dotted line B in FIG. 3A. FIG. 3C is an enlarged perspective view showing the vertically peripheral part enclosed by the dotted line C in FIG. 3A. FIG. 4A is a plan view showing the effective screen area of the color selection mask in the mask assembly of the second embodiment. FIG. 4B is an enlarged plan view showing the vertically central part of the color selection mask enclosed by the dotted line D in FIG. 4A. FIG. 4C is an enlarged plan view showing the vertically peripheral part enclosed by the dotted line E in FIG. 4A. In these drawings, structural elements common to the mask assembly of the first embodiment are designated by the same reference numerals.

The color selection mask 2A in the mask assembly according to the second embodiment has a region referred to herein as an alternating region (i.e., a first region) 12 in which the slits 4 alternate with the slot columns 5 in the H-direction as shown in FIG. 3B, and slot regions 13 (i.e., second regions) in which only slot columns 5 are arrayed in the H-direction as shown in FIG. 3C. In the slot regions 13, all metal strips 8 are interconnected by real bridges 7.

As shown in FIG. 4A, the alternating region 12 occupies the central part of the effective screen area in the V-direction. The slot regions 13 are formed on both sides of the alternating region 12 in the V-direction. As shown in FIG. 4B, the slits 4 in the alternating region 12 have a large number of dummy bridges 9 disposed at regular intervals in the V-direction as in the first embodiment. The slot columns 5 in the alternating region 12 have a large number of real bridges 7 spaced at regular intervals in the V-direction; the slots 6 are formed between adjacent real bridges 7.

As shown in FIG. 4C, the slot columns 5 in the slot region 13 have a structure in which a large number of real bridges 7 are disposed at regular intervals in the V-direction and slots 6 are formed between adjacent real bridges 7. In the slot region 13, the positions of the real bridges 7 in adjacent slot columns 5 are mutually shifted in the V-direction by approximately half the above-mentioned intervals.

Next, the effects of the mask assembly according to this second embodiment will be described. In the alternating region 12 of the color selection mask 2A in the mask assembly, there is an array of a large number of pairs of metal strips.8 joined by real bridges 7, referred to herein as joined metal strips, with slits 4 therebetween. Since slot regions 13 are formed on both sides of the color selection mask 2A in the V-direction, the length of the above-mentioned joined metal strips is shorter than in the first embodiment. Vibration accordingly has a larger eigenvalue than in the mask assembly of the first embodiment, so the amplitude of vibration caused by external impact can be reduced.

Compared to conventional real bridge tension masks, the regions (the slot regions 13) in which all metal strips are interconnected by real bridges 7 are restricted and are moreover adjacent to the alternating region 12, where vibration is effectively suppressed. Vibration propagation is therefore suppressed, and vibration of the entire surface of the color selection mask 2A is suppressed.

Since dummy bridges 9 are formed in the slits 4 in the alternating region 12, the total electron beam flux passing through the slits 4 can be made to approach the total flux passing through the slot columns 5, whereby brightness irregularities can be suppressed and picture quality can be improved.

As described above, the second embodiment provides the same effects as in the first embodiment: in the effective screen area of color selection mask, slits alternate with slot columns in the horizontal screen direction and dummy bridges are formed in the slits, whereby vibration of the color selection mask can be damped, doming and brightness irregularities can be prevented, and picture quality can be improved. Furthermore, since an increase in the rigidity of the mask frame is not required to prevent doming, it is possible to save weight and lower cost.

In addition, the amplitude of vibration caused by external impact is further reduced in the second embodiment.

### Third Embodiment

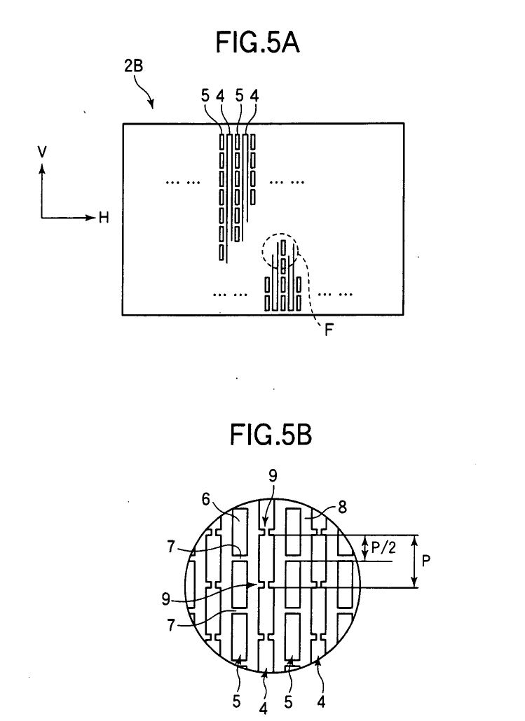

FIG. 5A is a plan view showing the effective screen area of the color selection mask 2B in a mask assembly according to a third embodiment. FIG. 5B is an enlarged plan view showing the part of the color selection mask 2B enclosed by the dotted line F in FIG. 5A. The mask assembly according to the third embodiment differs from the mask assembly according to the first embodiment in the shape of the openings for the passage of electron beams in the color selection mask 2B. In FIGS. 5A and 5B, structural elements common to the mask assembly according to the first embodiment are designated by the same reference numerals.

As shown in FIG. 5B, in the color selection mask 2B of the third embodiment, slits 4 alternate with slot columns 5 in the H-direction as in the first embodiment. The slits 4 have a large number of dummy bridges 9 disposed at regular intervals in the V-direction. As in the first embodiment, the slot columns 5 have a large number of real bridges 7 disposed at regular intervals in the V-direction; the slots 6 are formed between adjacent real bridges 7. The dummy bridges 9 of the slits 4 are disposed at approximately the same pitch (P) as the real bridges 7 of the slot columns 5. In addition, the dummy bridges 9 and real bridges 7 are disposed so that their positions are mutually shifted in the V-direction by approximately half this pitch (P/2).

Next, the effects of the mask assembly according to the third embodiment will be described. If there are horizontal rasters in which the dummy bridges 9 are aligned in the H-direction on the same line as the real bridges 7, the total electron beam flux passing through these rasters is reduced. Therefore, high and low luminance rasters may be intermixed on the screen, creating brightness irregularities. In the third embodiment, in contrast, since the dummy bridges 9 and real bridges 7 are disposed so that their positions are mutually shifted in the V-direction by approximately half the pitch P shown in FIG. 5B, the dummy bridges 9 are not aligned in the H-direction on the same line as the real bridges 7; the brightness irregularities described above can thereby be prevented.

As described above, according to the third embodiment, in addition to the effects of the first embodiment, brightness irregularities, in which rasters of different luminance are present, are eliminated by an arrangement in which the dummy bridges 9 of the slits 4 and the real bridges 7 of the slot columns 5 are mutually shifted by approximately half their pitch, and picture quality can be further improved.

The structure according to the third embodiment can also be applied to the mask assembly according to the second embodiment. For that purpose, in the alternating region 12 of the mask assembly shown in FIG. 3A, the dummy bridges 9 in the slits 4 and the real bridges 7 in the slot columns 5 can be disposed so that their positions are mutually shifted in the V-direction by approximately half their pitch. As a result, in addition to the above-described effects of the second embodiment, brightness irregularities, in which rasters of different luminance are present, can be eliminated, and picture quality can be further improved.

### Fourth Embodiment

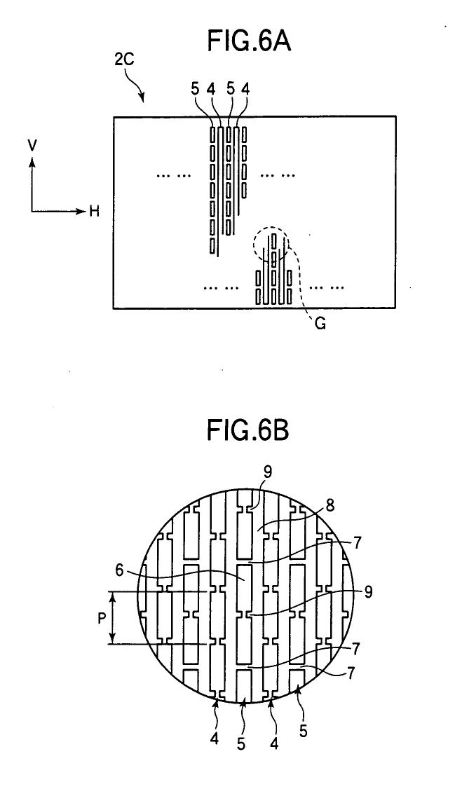

FIG. 6A is a plan view showing the effective screen area of the color selection mask 2C in a mask assembly according to a fourth embodiment. FIG. 6B is an enlarged plan view showing the part of the color selection mask 2C enclosed by the dotted line G in FIG. 6A. The mask assembly according to the fourth embodiment differs from the mask assembly according to the first embodiment in the shape of the openings formed in the effective screen area of the color selection mask 2C for the passage of electron beams. In FIGS. 6A and 6B, structural elements common to the first embodiment are designated by the same reference numerals.

As shown in FIG. 6B, in the mask assembly of the fourth embodiment, slits 4 alternate with slot columns 5 in the H-direction as in the first embodiment. The slits 4 have a large number of dummy bridges 9 disposed at regular intervals in the V-direction. The interval or pitch at which dummy bridges 9 occur in the slits 4 is designated by the letter P.

In the slot columns 5, a large number of real bridges 7 are formed at approximately the same pitch as the above pitch P, except that every second real bridge 7 is replaced by a dummy bridge 9. In other words, real bridges 7 alternate with dummy bridges 9 in the V-direction in the slot columns 5. The positions of the alternately formed real bridges 7 and dummy bridges 9 in the slot columns 5 are also shifted in the V-direction by approximately half the above-mentioned pitch (P/2) with respect to the positions of the dummy bridges 9 in the slits 4.

Next, the effects of the mask assembly according to the fourth embodiment will be described. According to the fourth embodiment, since some of the real bridges 7 in the slot columns 5 are replaced by dummy bridges 9, the total electron beam flux passing through the slot columns 5 can be made to approach the total electron beam flux passing through the slits 4 to make the two approximately equal. Brightness irregularities, in which columns of different luminance occur alternately, can thereby be suppressed. In addition, as described in the third embodiment, since the real bridges 7 and dummy bridges 9 in the slot columns 5 are disposed so that their positions are shifted by approximately half the pitch P with respect to the positions of the dummy bridges 9 in the slits 4, brightness irregularities can be further suppressed.

In the example shown in FIG. 6B, every second real bridge 7 in the slot columns 5 is replaced with a dummy bridge 9, but the present invention is not necessarily limited to this example; just a number of real bridges 7 sufficient to suppress brightness irregularities may be replaced with dummy bridges 9 in the slot columns 5 (preferably at intervals of approximately constant numbers of real bridges 7).

As described above, according to the fourth embodiment, in addition to the effects in the first embodiment, brightness irregularities, in which columns of different luminance occur alternately, can be further suppressed by replacing some of the real bridges 7 in the slot columns 5 with dummy bridges 9, and picture quality can be further improved.

The structure according to the fourth embodiment can be applied to the mask assembly according to the second embodiment. In this case, some of the real bridges 7 in the slot columns 5 in the alternating region 12 of the mask assembly shown in FIGS. 3A and 3B are replaced with dummy bridges 9, whereby, in addition to the effects in the second embodiment, picture quality can be further improved.

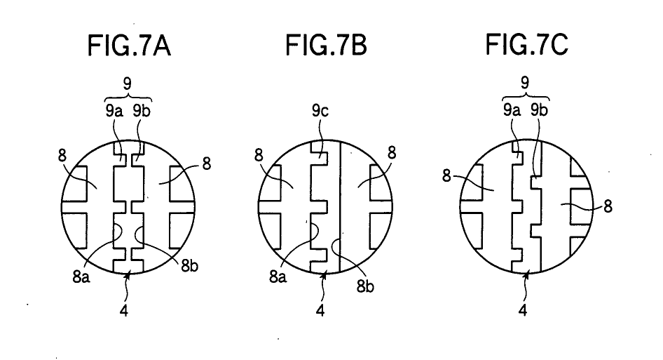

FIGS. 7A, 7B, and 7C are enlarged drawings illustrating structural variations of the dummy bridges 9 used in the preceding embodiments. In the first to fourth embodiments above, each dummy bridge 9 comprises a pair of projections 9a, 9b projecting from the mutually facing sides 8a, 8b of adjacent metal strips 8; the projections 9a, 9b face each other across a gap, as shown in FIG. 7A. If necessary, however, the optimum shape and placement of the dummy bridges can be selected from further arrangements. For example, as shown in a first modified example in FIG. 7B, the dummy bridges may comprise projections 9c projecting from a side 8a of just one metal strip 8 toward the facing side 8b of the adjacent metal strip 8. Further, as shown in a second modified example in FIG. 7C, when the dummy bridges 9 comprise projections 9a, 9b projecting from the mutually facing sides 8a, 8b of adjacent metal strips 8, the positions of the projections 9a, 9b may be mutually offset in the V-direction by, for example, approximately half the pitch interval.

Those skilled in the art will recognize that further variations are possible within the scope of the invention, which is defined by the appended claims.

What is claimed is:

1. A mask assembly for a color cathode ray tube, the mask assembly including a color selection mask and a mask frame supporting the color selection mask, the color selection mask having the form of a thin metal plate with a plurality of openings for the passage of electron beams, the color selection mask having an effective screen area within which a horizontal screen direction and a vertical screen direction are defined, wherein:
the openings in the effective screen area include slits and columns of slots both extending in the vertical screen direction, the slots extending for a shorter distance than the slits in the vertical screen direction, the slits alternating with the columns of slots in the horizontal screen direction; and
the thin metal plate comprises metal strips that separate the slits from the columns of slots, thereby bounding the columns of slots,
a plurality of real bridges joining the pair of metal strips bounding each column of slots so as to define boundaries between the slots in the column of slots, and
a plurality of dummy bridges projecting from the metal strips into each of the slits without joining the metal strips.

2. The mask assembly of claim 1, wherein each of the dummy bridges comprises a pair of projections projecting from the pair of metal strips on both sides of one of the slits, the projections facing each other across a gap.

3. The mask assembly of claim 1, wherein the dummy bridges and the real bridges are disposed at substantially identical intervals in the vertical screen direction, and the positions of the dummy bridges are shifted in the vertical screen direction by substantially half the substantially identical intervals with respect to the positions of the real bridges.

4. The mask assembly of claim 1, wherein the columns of slots have dummy bridges in addition to the real bridges.

5. The mask assembly of claim 5, wherein the real bridges in each column of slots are replaced with dummy bridges at intervals of substantially a constant number of the real bridges in the vertical screen direction.

6. The mask assembly of claim 1, further comprising a vibration damping mechanism for dumping vibration of the color selection mask.

7. The mask assembly of claim 6, wherein the vibration damping mechanism comprises a pair of damper springs and a damper wire, the damper springs being secured to the mask frame, the damper wire being suspended between the pair of damper springs and directly contacting the color selection mask.

8. A cathode ray tube including the mask assembly of claim 1, having a faceplate on an inner surface of which a phosphor screen is formed, the phosphor screen facing the color selection mask in the mask assembly.

9. A mask assembly for a color cathode ray tube, the mask assembly including a color selection mask and a mask frame supporting the color selection mask, the color selection mask having the form of a thin metal plate with a plurality of openings for the passage of electron beams, the color selection mask having an effective screen area within which a horizontal screen direction and a vertical screen direction are defined, wherein:
the effective screen area comprises a first region and a second region, the first region having slits and columns of slots both extending in the vertical screen direction, the slots extending for a shorter distance than the slits in the vertical screen direction, the slits alternating with the columns of slots in the horizontal screen direction, the second region having columns of slots extending in the vertical screen direction; and
the thin metal plate comprises metal strips that separate the slits from the columns of slots in the first region, and separate adjacent columns of slots in the second region, thereby bounding the columns of slots in both the first and second regions,
a plurality of real bridges joining the pair of metal strips bounding each column of slots so as to define boundaries between the slots in the column of slots, and
a plurality of dummy bridges projecting from the metal strips into each of the slits without joining the metal strips.

10. The mask assembly of claim 9, wherein the first region occupies the vertically central part of the effective screen area, and the second region is disposed on both sides of the first region in the vertical screen direction.

11. The mask assembly of claim 9, wherein each of the dummy bridges comprises a pair of projections projecting from the pair of metal strips on both sides of one of the slits, the projections facing each other across a gap.

12. The mask assembly of claim 9, wherein the dummy bridges and the real bridges are disposed at substantially identical intervals in the vertical screen direction, and the positions of the dummy bridges are shifted in the vertical screen direction by substantially half the substantially identical intervals with respect to the positions of the real bridges.

13. The mask assembly of claim 9, wherein the columns of slots have dummy bridges in addition to the real bridges.

14. The mask assembly of claim 13, wherein the real bridges in each column of slots are replaced with dummy bridges at intervals of substantially a constant number of the real bridges in the vertical screen direction.

15. The mask assembly of claim 9, further comprising a vibration damping mechanism for dumping vibration of the color selection mask.

16. The mask assembly of claim 15, wherein the vibration damping mechanism comprises a pair of damper springs and a damper wire, the damper springs being secured to the mask frame, the damper wire being suspended between the pair of damper springs and directly contacting the color selection mask.

17. A cathode ray tube including the mask assembly of claim 9, having a faceplate on an inner surface of which a phosphor screen is formed, the phosphor screen facing the color selection mask in the mask assembly.
